(19) United States
(12) Patent Application Publication
(10) Pub. No.: US 2022/0369069 A1
(43) Pub. Date: Nov. 17, 2022

(54) MODIFYING AN EVENT-BASED POSITIONING PROCEDURE CONFIGURED IN A WIRELESS DEVICE

(71) Applicant: Telefonaktiebolaget LM Ericsson (publ), Stockholm (SE)

(72) Inventors: Åke Busin, Sollentuna (SE); Ritesh Shreevastav, Upplands Väsby (SE); Yazid Lyazidi, Hässelby (SE); Satyam Dwivedi, Solna (SE)

(21) Appl. No.: 17/739,304

(22) Filed: May 9, 2022

Related U.S. Application Data
(60) Provisional application No. 63/186,915, filed on May 11, 2021.

(51) Int. Cl. H04W 4/029

(52) U.S. Cl. CPC H04W 4/029

(57) ABSTRACT

A network node of a wireless communication network configures a wireless device to perform a positioning procedure responsive to occurrences of a defined event, and the wireless device subsequently modifies one or both the positioning measurement instructions and positioning assistance data used for performing one or more future occurrences of the positioning procedure, responsive to receiving modification signaling. Consequently, the network node avoids the signaling burden associated with configuring a new triggered or periodic procedure, while having the ability to modify the ongoing procedure to account for, for example, movements of the wireless device.

### RELATED APPLICATIONS

This application claims priority from U.S. Provisional Application No. 63/186,915 filed 11 May 2021. The entire contents of the aforementioned application is incorporated herein.

### TECHNICAL FIELD

The present invention generally relates to positioning operations in the context of a wireless communication network and wireless devices configured for operation therein.

### BACKGROUND

Positioning of wireless devices has growing importance in contemporary communication networks, with various types of wireless communication networks including features and functions that support positioning of wireless devices that use the network for various types of communication services. Here, a wireless device is essentially any type of equipment that includes wireless communication circuitry and any associated credentialing needed for connecting to a wireless communication network via the involved Radio Access Technology (RAT) or RATs, according to the applicable air interface details.

For example, a wireless device may be a user terminal operated by a human, such as a smartphone or tablet, or may be a Machine Type Communication (MTC) device, such as an embedded controller or sensor. The term “User Equipment” or “UE” is interchangeable with “wireless device” in the context of this disclosure, with the term “UE” emphasizing that wireless devices of interest herein are end-user devices that consume communication services provided by or through a supporting wireless communication network.

The Third Generation Partnership Project (3GPP) promulgates comprehensive sets of specifications, referred to as “Releases,” with the various releases defining operational details for respective generations or iterations of wireless communication networks. Positioning of wireless devices is one area under active development by the 3GPP. The 3GPP Technical Specification (TS) 37.355 v16.4.0 defines a positioning protocol referred to as “LTE Positioning Protocol” or “LPP,” where “LTE” denotes Fourth Generation (4G) “Long Term Evolution.”

LPP is a point-to-point protocol between a location server and a target device, supporting positioning of the target device using positioning-related measurements obtained by one or more reference sources. A typical “target device” is a UE, and “positioning” refers to the determination of the location of the UE, either in absolute or relative terms. Example location servers are Enhanced Serving Mobile Location Centers or “E-SMLCs,” Location Management Functions or “LMFs.” As an example, a LMF uses LPP to communicate with a UE, to configure the UE for positioning measurements, e.g., measurements made by the UE on Positioning Reference Signals (PRSs).

The 3GPP TS 23.273 V16.6.0 defines operations and signaling for LoCation Services (LCS) in Fifth Generation Systems (5GS). A 5GS comprises a 5G Core (5GC) and a Radio Access Network (RAN), such as a 5G New Radio (NR) RAN. The '273 specification defines a number of location service procedures, including one addressing regulatory location services and referred to as the “Deferred 5GC-MT-LR Procedure for Periodic, Triggered and UE Available Location Events.” Here, “MT” denotes “mobile terminated” and “LR” denotes “location reporting.” See Section 6.3 of the '273 specification, with Item 1 in Section 6.3.1 explaining that:
The external location services client or the AF (via NEF) sends a request to the (H)GMLC for location reporting for periodic, triggered or UE available location events. The request is sent as described for step 1 in clause 6.1.2 with the differences described here. The LCS Service Request provides the type of periodic or triggered location reporting being requested and associated parameters. For periodic location, the LCS Service Request includes the time interval between successive location reports, the total number of reports and may include location QoS. For area event reporting, the LCS Service Request includes details of the target geographical area, whether the event to be reported is the UE being inside, entering into or leaving the target area, the duration of event reporting, the minimum and maximum time intervals between successive event reports, the maximum event ETSI 3GPP TS 23.273 version 16.9.0 Release 16 45 ETSI TS 123 273 V16.9.0 (2022-01) sampling interval, whether location estimates shall be included in event reports (and associated location QoS), and whether only one location report is required or more than one. If the target area is expressed by a local coordinate system or a geopolitical name, the (H)GMLC shall convert the target area to a geographical area expressed by a shape as defined in TS 23.032 [8]. For motion event reporting, the LCS Service Request includes the threshold linear distance, the duration of event reporting, the minimum and maximum time intervals between successive event reports, the maximum event sampling interval, whether location estimates shall be included in event reports (and associated location QoS), and whether only one location report is required or more than one.

With respect to FIG. 6.3.1-1 depicted in Section 6.3.1 of the '273 specification, several steps of the Deferred 5GC-MT-LR Procedure for Periodic, Triggered and UE Available Location Events are of particular interest. FIGS. 1A and 1B illustrate the procedure.

In Step 15, the LMF performs one or more of the positioning procedures described in clauses 6.11.1, 6.11.2 and 6.11.3 of the '273 specification, and in clause 6.1.1., step 8. During this step, the LMF may request and obtain the UE positioning capabilities (e.g., which may indicate the type(s) of periodic and triggered location supported by the UE and the access types supported by the UE for event reporting). The LMF may also obtain the UE location—e.g., for a request for the UE available location event or when an initial location is requested for periodic or triggered UE location. For a request for the UE available location event, the LMF skips steps 16 and 17.

In step 16, if periodic or triggered location was requested, the LMF sends a supplementary services LCS Periodic-Triggered Invoke Request to the UE via the serving Access and mobile Management Function (AMF), by invoking the Namf_Communication_N1N2MessageTransfer service operation. The LCS Periodic-Triggered Location Invoke carries the location request information received from the AMF at step 14, including the (H)GMLC contact address and LDR reference number.

The LCS Periodic-Triggered Location Invoke also includes a deferred routing identifier, which can be the identification of the LMF when the LMF will act as a serving LMF or a default LMF identification otherwise. The LCS Periodic-Triggered Location Invoke may indicate the allowed access types for event reporting at step 25 (e.g. one or more of NR, E-UTRA connected to 5GC, E-UTRA connected to EPC, non-3GPP access connected to 5GC) and may include an embedded positioning message which indicates certain allowed or required location measurements (or a location estimate) at step 25 for each location event reported (e.g. based on the positioning capabilities of the UE obtained in step 14 and the allowed access types). As part of NAS transport of the LCS Periodic-Triggered Location Invoke from the serving AMF to the UE, the serving AMF includes an immediate routing identifier in the NAS transport message containing an LCS Correlation identifier—e.g., according to clause 6.11.1.

In Step 23, the UE obtains any location measurements or a location estimate that were requested or allowed at step 16. In Step 25, the UE sends a supplementary services event report message to the LMF which is transferred via the serving AMF (which may be different from the original serving AMF for steps 14-16) and is delivered to the LMF using an Namf_Communication_N1MessageNotify service operation. The event report may indicate the type of event being reported (e.g., whether a normal event or expiration of the maximum reporting interval) and may include an embedded positioning message which includes any location measurements or location estimate obtained at step 23.

The UE also includes the deferred routing identifier received in step 16 in the NAS Transport message used to transfer the event report from the UE to the AMF. The AMF then forwards the event report to either the serving LMF or any suitable LMF based on whether the deferred routing identifier indicates a particular LMF or any (default) LMF. If a different LMF than the serving LMF is used, procedure in clause 6.4 is used. The UE also includes the (H)GMLC contact address, the LDR reference number, whether location estimates are to be reported and if so the location Quality-of-Service (QoS) in the event report.

In Step 27, if a location estimate is needed for event reporting, the LMF may perform one or more of the positioning procedures described in clauses 6.11.1, 6.11.2 and 6.11.3 and in clause 6.1.1, step 8. The LMF then determines the UE location using the location measurements and/or location estimate(s) obtained at this step and/or received at step 25. In Step 31, the UE continues to monitor for further periodic or trigger events as in step 22 and instigates steps 23-30 each time a trigger event is detected.

There currently exist certain challenge(s). For example, the LMF in step 16 may send “allowed or required location measurements” to be performed by the UE at step 23. However, if the LMF at later stage, e.g., during event reporting (step 25), finds that UE has moved, such that initial positioning configuration is no longer optimal, no mechanism exists to change the positioning configuration. This problem can occur, for example, in scenarios where a UE moves from an indoor area getting coverage from dedicated indoor cells to an outdoor area with more sparsely deployed outdoor cells. For such scenarios, the optimal positioning method might change from a RAT-dependent method such as DL-TDOA to A-GNSS.

In factory environments, it may be that the next periodical positioning is merely tracking the device rather than performing the positioning tracking, e.g., to identify relative position or obtain the device trajectory. Simple tracking of that sort may be achieved by displacement reporting (e.g., based on motion-sensor standardized in Release 15, see TS 37.355 v 16.4.0). Hence, the positioning method to be used by a UE may change from a RAT-dependent positioning methodology to a sensor-based positioning methodology, for tracking purposes. See Section 8.8.2.2 of 3GPP TS 38.305 v16.4.0 for example details regarding motion-sensor based positioning. Further, assuming that the '273 specification is changed such that step 16 in FIG. 6.3.1-1 is extended so that multiple embedded positioning messages can be included, the problem of changed circumstances may also apply to assistance data that is provided to the UE.

### SUMMARY

A network node of a wireless communication network configures a wireless device to perform a positioning procedure responsive to occurrences of a defined event, and the wireless device subsequently modifies one or both the positioning measurement instructions and positioning assistance data used for performing one or more future occurrences of the positioning procedure, responsive to receiving modification signaling. Consequently, the network node avoids the signaling burden associated with configuring a new triggered or periodic procedure, while having the ability to modify the ongoing procedure to account for, for example, movements of the wireless device.

An example embodiment comprises a method performed by a wireless device, the method including the wireless device receiving a positioning configuration from a network node of a wireless communication network, wherein the positioning configuration defines a positioning procedure to be performed by the wireless device responsive to occurrences of a defined event. Further, the positioning configuration indicates the defined event and comprises positioning measurement instructions and positioning assistance data to be used by the wireless device for performing the positioning procedure. The method further includes configuring the wireless device for operation according to the positioning configuration, and receiving modification signaling while the wireless device is operating according to the positioning configuration. In response to the modification signaling, the wireless device modifies at least one of the positioning-measurement instructions or the positioning-assistance data, for use with respect to one or more future occurrences of the defined event.

A corresponding embodiment comprises a wireless device comprising communication interface circuitry and processing circuitry. The processing circuitry is configured to receive, via the communication interface circuitry, signaling from a network node of a wireless communication network, where the signaling conveys a positioning configuration defining a positioning procedure to be performed by the wireless device responsive to occurrences of a defined event.

The positioning configuration indicates the defined event and comprises positioning measurement instructions and positioning assistance data to be used by the wireless device for performing the positioning procedure. Correspondingly, the processing circuitry is configured to configure the wireless device for operation according to the positioning configuration, and receive, via the communication interface circuitry, modification signaling while the wireless device is operating according to the positioning configuration. In response to the modification signaling, the processing circuitry is configured to modify at least one of the positioning-measurement instructions or the positioning-assistance data, for use with respect to one or more future occurrences of the defined event.

Another embodiment comprises a method performed by a network node of a wireless communication network. The method includes the network node sending a positioning configuration defining a positioning procedure to be performed by a wireless device responsive to occurrences of a defined event. The positioning configuration indicates the defined event and comprises positioning measurement instructions and positioning assistance data to be used by the wireless device for performing the positioning procedure. The method further includes the network node determining one or more modifications for at least one of the positioning-measurement instructions and the positioning-assistance data, and sending modification signaling while the wireless device is operating according to the positioning configuration, to thereby modify at least one of the positioning-measurement instructions or the positioning-assistance data at the wireless device with respect to one or more future occurrences of the defined event.

A corresponding embodiment comprises a network node of a wireless communication network. The network node includes communication interface circuitry and processing circuitry. The processing circuitry is configured to send, via the communication interface circuitry, a positioning configuration defining a positioning procedure to be performed by a wireless device responsive to occurrences of a defined event, where the positioning configuration indicates the defined event and comprises positioning measurement instructions and positioning assistance data to be used by the wireless device for performing the positioning procedure. Further, the processing circuitry is configured to determine one or more modifications for at least one of the positioning-measurement instructions and the positioning-assistance data, and send, via the communication interface circuitry, modification signaling while the wireless device is operating according to the positioning configuration. The modification signaling modifies at least one of the positioning-measurement instructions or the positioning-assistance data at the wireless device with respect to one or more future occurrences of the defined event.

Of course, the present invention is not limited to the above features and advantages. Those of ordinary skill in the art will recognize additional features and advantages upon reading the following detailed description, and upon viewing the accompanying drawings.

### BRIEF DESCRIPTION OF THE DRAWINGS

FIGS. 1A and 1B depict a defined signaling flow used to configure deferred location requests for periodic, triggered and UE available location events.

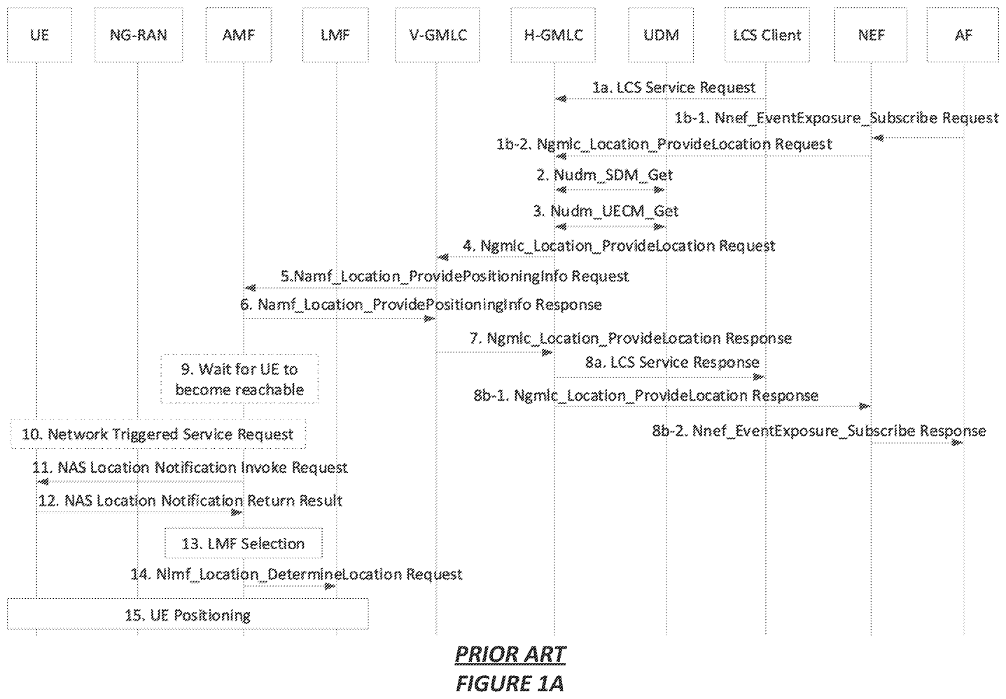

FIGS. 2A and 2B depict an advantageous modification of the signaling flow shown in FIGS. 1A and 1B, according to an example embodiment.

FIG. 3 is a block diagram that illustrates a wireless communication network, according to an example embodiment.

FIG. 4 is a block diagram that illustrates a network base station, according to an example embodiment.

FIGS. 5 and 6 are block diagrams that illustrate example implementations of a Transmission Reception Point (TRP).

FIG. 7 is a block diagram that illustrates an example arrangement of TRPs with respect to “cells” of a wireless communication network.

FIG. 8 is a block diagram that illustrates an example arrangement of geographic areas, such as may be subdivided into sectors or other divisions.

FIG. 9 is a block diagram that illustrates example details for the wireless communication network introduced in FIG. 3.

FIG. 10 is a block diagram illustrates example implementations of a Location Management Function (LMF), a Base Station (BS), and a User Equipment (UE).

FIG. 11 is a logic flow diagram that illustrates a method performed by a LMF, according to an example embodiment.

FIG. 12 is a block diagram that illustrates another example implementation of a LMF.

FIG. 13 is logic flow diagram that illustrates a method performed by a UE, according to an example embodiment.

FIG. 14 is a block diagram that illustrates another example implementation of a UE.

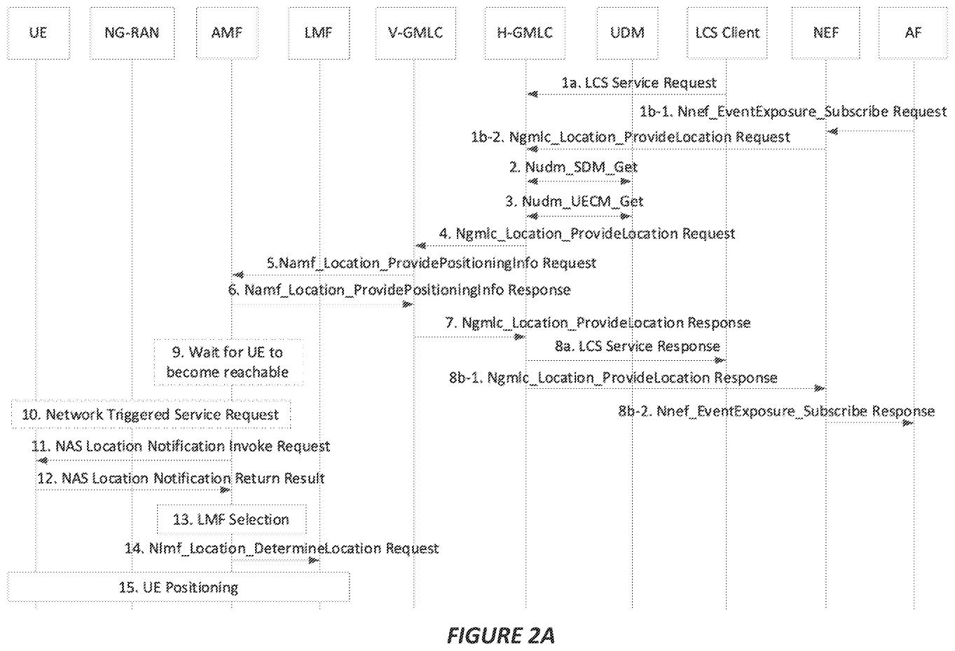

FIG. QQ1 is a block diagram that illustrates a communication system, which includes a host and a telecommunication network, such as the wireless communication network introduced in FIG. 3.

FIG. QQ2 is a block diagram that illustrates another example implementation of a UE.

FIG. QQ3 is a block diagram that illustrates an example implementation of a network node, such as a network base station.

FIG. QQ4 is a block diagram that illustrates an example implementation a host, such as the host depicted in the communication system of FIG. QQ1.

FIG. QQ5 is a block diagram that illustrates an example virtualization environment that implements virtualized functions.

FIG. QQ6 is a block diagram that illustrates example communications and corresponding operations for respective elements of the communication system of FIG. QQ1.

### DETAILED DESCRIPTION

Certain aspects of the disclosed subject matter and respective embodiments disclosed herein may provide solutions to the challenges identified in the background of this disclosure or address other challenges. In one or more embodiments, the disclosure describes methods and apparatuses for updating measurement instructions and assistance data that may be included when initiating a trigger in the UE as part of a 5GC deferred MT-LR procedure or 5GC deferred MO-LR procedure, where “MO” refers to “Mobile Originated.”

Certain embodiments may provide one or more of the following technical advantages. Techniques described herein provide, in one or more embodiments, for updating the measurement instructions and assistance data that may be included when initiating a trigger in the UE as part of a 5GC deferred MT-LR procedure. Related or additional advantages include:
An LMF can easily modify measurement instructions or assistance data within an ongoing procedure in the target UE.
No addition signaling needed when the “modification” option is not utilized.
No interaction with a Gateway Mobile Location Center (GMLC) or LCS Client/Application Function (AF) is needed.
Deferred positioning becomes more seamless in scenarios involving UE movement between different types of environments, e.g., between indoors and outdoors.
Allows an LMF to change positioning-measurement instructions followed by the UE and/or the positioning-assistance data used by a UE when positioning resources change (e.g., change of available Positioning Reference Signals), without disturbing the ongoing periodicity or other event definition providing for repeated or triggered performance of positioning operations at the UE.
More network flexibility, in case the assistance data would need to be obtained or provided via RRC Inactive state using small data transmission or early data transmission framework.

In at least one embodiment, the disclosed techniques preserve “continuity” or “coherency” with respect to a positioning configuration that involves periodic performance of a positioning operation, or otherwise involves a repeating positioning operation performed on a triggered basis. For example, an initial configuring operation between a network node and a UE defines the positioning procedure and the periodicity or other triggering basis and provides initial positioning measurement instructions and/or positioning-assistance data. Rather than upsetting the periodicity or otherwise “restarting” the positioning procedure, modification signaling as disclosed herein provides a lean mechanism for modifying the positioning-measurement instructions and/or the positioning-assistance data, without disturbing the trigger definition.

In an example, an initial or original positioning configuration sent from the network to a UE defines an event-based positioning procedure wherein the UE is to perform measurements according to positioning-measurement instructions and in dependence on positioning-assistance data, responsive to fulfillment of a defined event. Non-limiting example events include timer-based events, such as periodic triggering at a defined periodicity, and location or movement-based events, such as triggering the procedure responsive to moving by more than a defined amount.

In at least one embodiment, the basic steps from the perspective of a LMF or other network node of a wireless communication network include the following details. After having sent an LCS Periodic-Triggered Invoke Request and received acknowledgement from a UE, the LMF determines a need to add or modify measurement instructions or assistance data that was included as LPP message(s) embedded in the LCS Periodic-Triggered Invoke Request message. Correspondingly, the LMF sends a complementing Periodic-Triggered Location Invoke. The message contains information identifying the ongoing procedure in the UE plus LPP message(s) that include the additional or modified measurement instructions or assistance data.

These embedded LPP messages may be understood as an example of modification signaling that leaves the periodic triggering undisturbed, while changing how or what the UE measures and reports. Leaving the underlying reporting configuration unchanged while modifying what the UE measures or how the UE reports measurements offers significant flexibility and represents a “lean” signaling approach.

From the UE perspective, upon receiving an LCS Periodic-Triggered Invoke Request where the message contains information identifying it to be associated with an ongoing procedure in UE, the UE reads any embedded LPP message(s) and applies any included additional or modified measurement instructions or assistance data to the ongoing procedure. That, while operating according to a previously-received LCS Period-Triggered Invoke Request message, the UE receives one or more embedded LPP messages that modify the measurement instructions and/or assistance data that was provided in the Request.

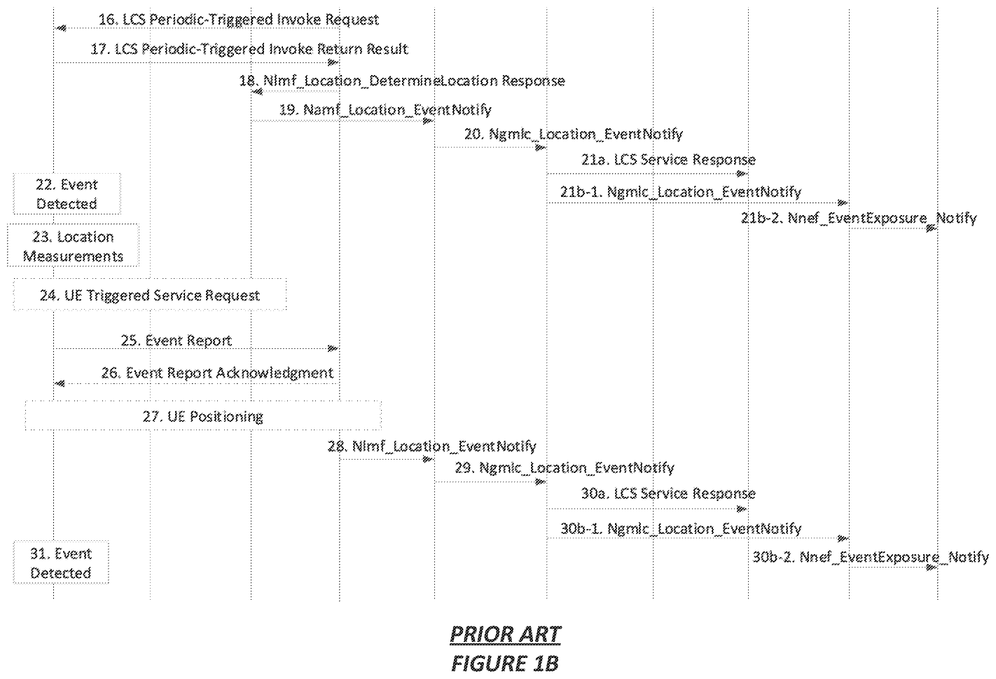

An example embodiment involves a modification of the signaling depicted in FIG. 6.3.1-1 of 3GPP TS 23.273, providing an advantageous mechanism for modifying the assistance data or measurement configuration of a UE that is configured via a Deferred 5GC-MT-LR Procedure for Periodic, Triggered and UE Available Location Events. See FIGS. 2A and 2B, with particular on details shown as “Step 27a.” Step 27a represents heretofore unavailable “modification” capabilities, for modifying aspects of the positioning configuration provided to the UE in Step 16.

Regarding Step 27a, the LMF may update the Periodic-Triggered Location Invoke by repeating steps 16 and 17 with the difference that only information identifying the procedure in UE and information that are modified are included. This also applies to any embedded positioning message. The term “embedded positioning message” is in this context an LPP (TS 37.355) message. In this context or in other contexts, it may be assumed that LPP (TS 37.355) defines how the UE shall act on modified measurement instructions or modified Assistance Data provided to it via the “modification signaling” approach represented in Step 27a.

As one example of providing modified information in LPP, the LMF may notify the UE as to whether positioning is preferred, or whether tracking is desired. Tracking may be coarser or may simply indicate direction of movement, or speed, or proximate sensors, etc. The tracking versus positioning indication may be represented by a flag or enumeration included in the ANS1 content in the CommonIEsRequestLocationInformation information elements (IEs) defined in Section 6.4.2 of 3GPP TS 37.355 v16.4.0. The proposed modification adds an optional “nextDeferredMeasurementReporting” IE, which in one or more examples is defined as:

NextDeferredMeasurementReporting-r17 ::= SEQUENCE {

| | |
|---|---|
| measurementType-r17 | ENUMERATED {onlyTracking, hybrid, ratDependent, |
| | ratIndependent, onlyZ-component} |

OPTIONAL Need ON

| | |
|---|---|
| reportingModeSDT-r17 | ENUMERATED {true} OPTIONAL -- Need ON |

In the above ANS1 example, the “onlyTracking” flag or enumeration would imply performance by the UE of a sensor-based positioning method. An only z-component indication would imply vertical location (height) computation is needed. In such cases, the involved LMF may specify that the measurement report can be small and hence “small data” transmission can be used.

Small data transmissions were introduced in LTE with the focus on Machine Type Communication (MTC). For example, Rel-15 Early Data Transmission (EDT) and Rel-16 Preconfigured Uplink Resources (PUR) have been standardized for LTE-M and NB-IoT. Unlike these features, the Rel-17 Small Data transmission for NR is not directly targeting MTC use cases and the Work Item Description includes smartphone background traffic as the justification. The main purpose is that UE should be able to transmit the data in Msg3 and receive in Msg4; basically, the UL/DL data transmission can be performed in RRC Inactive mode.

The LMF may also indicate what the next reporting mode should be for the tracking, such as whether to use small data transmission/early data transmission or not. This indication may also be considered as a recommendation to the UE on which transmission mode should be used.

FIG. 3 illustrates one embodiment of a wireless communication network 10, which includes a number of Transmission/Reception Points (TRPs) 12, each providing radio coverage in one or more respective service areas 14, also referred to as coverage areas. For ease of illustration, only three TRPs 12 are shown, 12-1, 12-2, and 12-3, each providing a respective one of coverage areas 14-1, 14-2, and 14-3. The network 10 comprises, in an example embodiment, a 5G network proving NR air interfaces. However, such an example is non-limiting.

The coverage areas 14 may be understood as the use of particular resources—time, frequency, spatial (beam), etc.—to provide communication services to a respective geographic area. In one example, each TRP 12 includes or is associated with one or more transmit/receive antennas 16, which provide for downlink (DL) signal transmission to wireless devices 20 and uplink (UL) signal reception from wireless devices 20. Each TRP 12 may serve multiple wireless devices 20, and wireless devices 20 may move from one coverage area 14 to another. In that regard, neighboring coverage areas 14 may be overlapping.

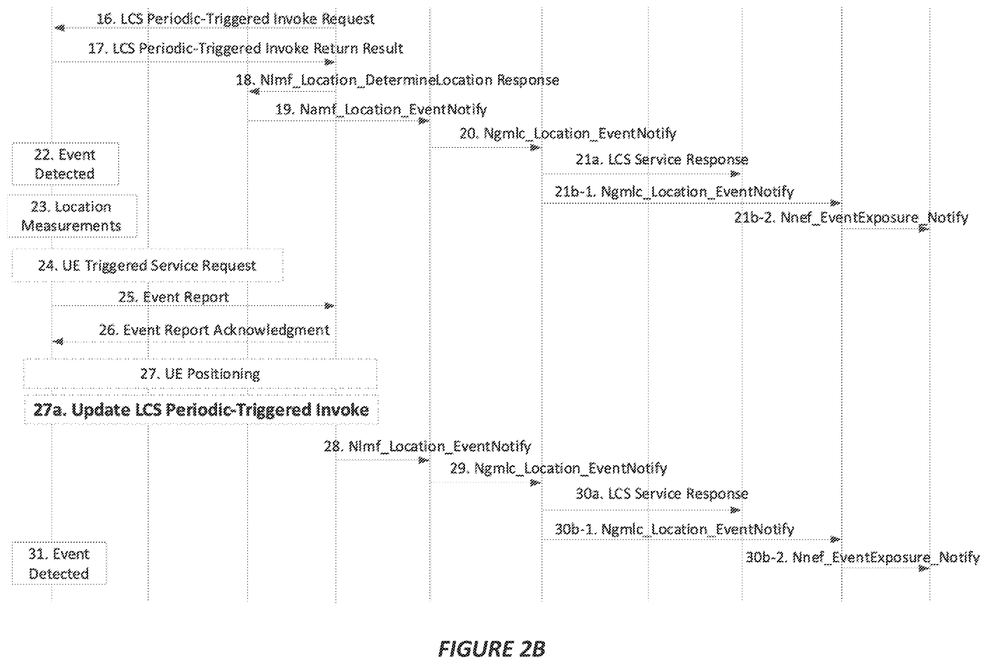

FIG. 4 illustrates an example network base station (BS) 30, which provides one or more network “cells” 32. For example, the BS 30 may use different carrier frequencies or frequency bands for each such cell 32, such that cells operating on different frequency resources may cover the same geographic area or at least partly overlap in terms of geographic coverage. The BS 30 may be understood as one implementation of a TRP 12, and the cells 32 may be understood as example realizations of one or more coverage areas 14. Generally, at least some transmissions by the BS 30 include some sort of cell or BS identification.

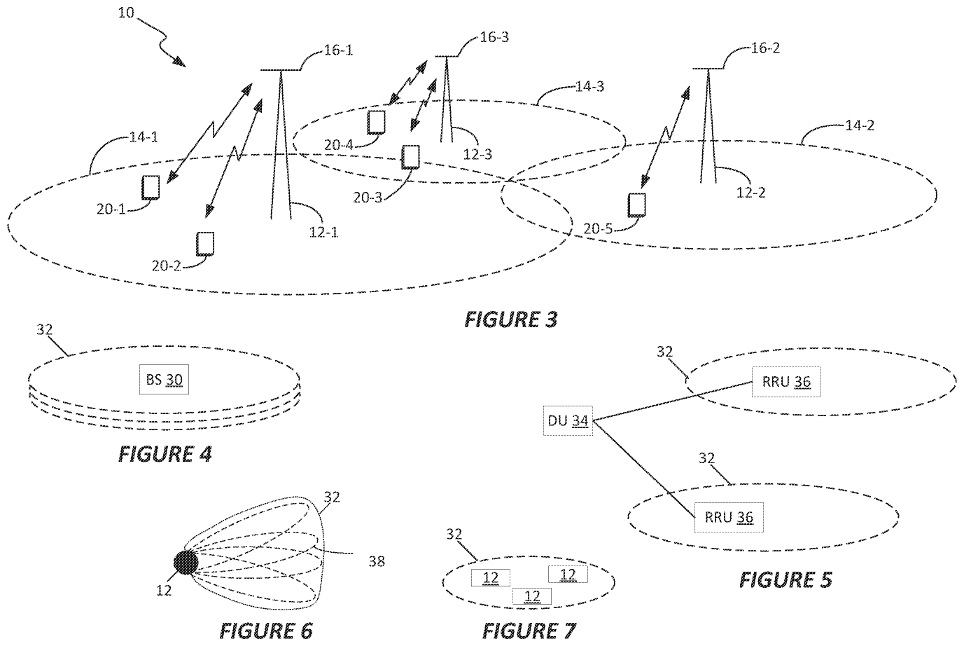

FIG. 5 illustrates another approach to implementing a TRP 12 and one or more respective coverage areas 14. Here, a digital unit (DU) 34 interfaces with multiple remote radio units (RRUs) 36, with each RRU 36 providing one or more cells 32. The interfaces between the DU 34 and the RRUs 36 are Common Public Radio Interfaces (CPRIs), for example.

FIG. 6 illustrates yet another approach to implementing a TRP 12 and one or more respective coverage areas. Here, a TRP 12, which may be a self-contained BS 30 or a distributed DU/RRU arrangement, provides a cell 32 via beamforming on the DL and/or the UL. Particularly, the TRP 12 provides radio coverage using beams 38, with each beam 38 having a particular direction (horizontal and/or vertical angles) and shape and providing radio coverage along that beam direction. The TRP 12 may transmit multiple beams 38 at once, or it may use a sweeping or other pattern, in which it transmits one or a select few beams at a time, according to some repeating cycle.

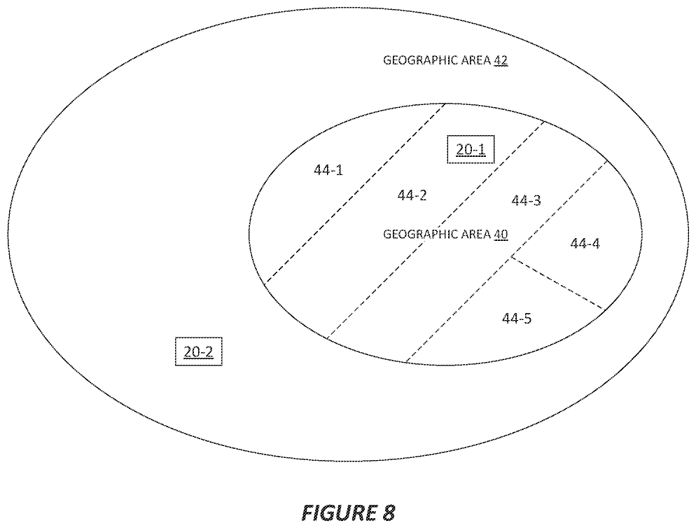

Finally, FIG. 7 illustrates an example arrangement wherein one cell 32 contains multiple TRPs 12, with the respective coverage areas 14 of the individual TRPs all being part of the same cell 32. Such an arrangement may be realized, for example, using a distributed antenna system, or some other arrangement, such as the DU/RRU arrangement of FIG. 3.

One point to appreciate from FIGS. 3-7 is that there may be a one-to-one relationship between cells 32 and TRPs 12, or there may be a one-to-many relationship, such as seen in FIG. 7. Thus, a TRP 12 may be identified by providing its identity if it has a unique identity within the network domain of interest. Alternatively, a TRP may be identified, at least indirectly, according to a beam, cell, or sector identification with which it is associated.

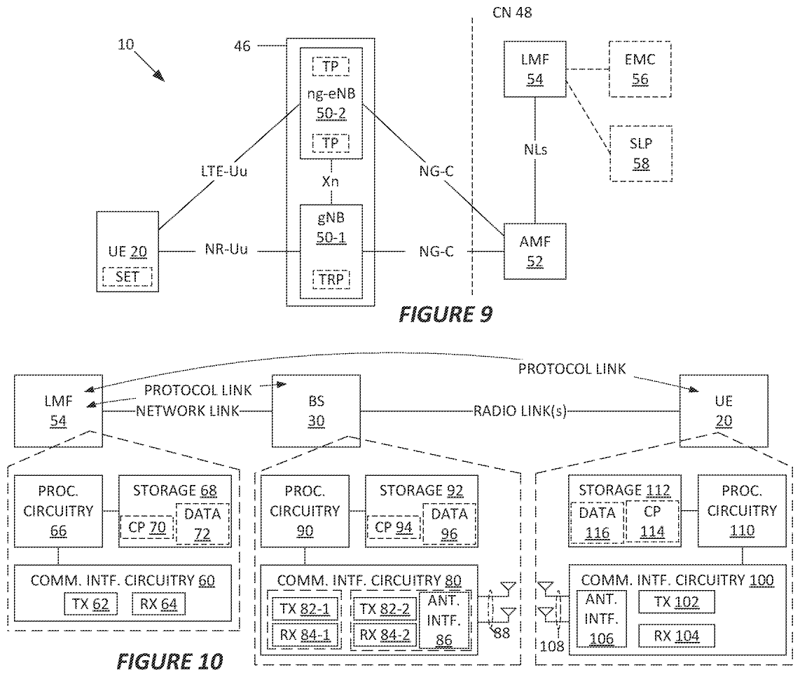

FIG. 8 illustrates an example arrangement of geographic areas, including a geographic area 40 that is contained within a larger geographic area 42. In one or more embodiments, the geographic area 40 may have different sectors or divisions 44. A communications network 10 provides communication-service coverage over the geographic areas 40 and 42. For example, the larger geographic area 42 may correspond to an overall set of cells 32 or, more generally, coverage areas 14, and the geographic area 40 may correspond to a particular subset of those cells 32 or coverage areas 14. As such, there may be an overall set or collection of TRPs 12 associated with the larger geographic area 42 and a subset of TRPs 12 associated with smaller geographic area 40.

As an example, the geographic area 40 represents an industrial area, such as a factory or warehouse, and positioning considerations for wireless devices 20 that are within the geographic area 40 may differ from those for wireless devices 20 that are outside of the geographic area 40. The figure shows a wireless device 20-1 operating inside the geographic area 40 and a wireless device 20-2 operating outside the geographic area 40. Of course, there may be many wireless devices 20 both inside and outside of the geographic area 40 and there may be wireless devices 20 within the geographic area 40 that are moving from one sector 44 to another sector 44, e.g., according to some known or estimable path or trajectory.

By way of example, five sectors 44-1 through 44-5 are shown. In one example, one or more wireless devices 20 comprise or are included on/in mobile robots or other mobile platforms, such as autonomous guided vehicles (AGVs) or the like, and they move within the geographic area 40, which may also be referred to as an “environment.” There may be general broadcasting of (positioning) assistance data for the whole geographic area 40.

In one aspect of the techniques disclosed herein, an LMF or other network node of a wireless communication sends a positioning configuration for a wireless device. The positioning configuration defines a positioning procedure to be performed by a wireless device responsive to occurrences of a defined event, with the positioning configuration indicating the defined event and comprising positioning measurement instructions and positioning assistance data to be used by the wireless device for performing the positioning procedure.

The positioning measurement instructions suit, for example, any one or more of the device's current location, the desired type or nature of positioning, the availability of resources in the network and/or with respect to the current location or operating area of the wireless device. The more general point here is that conditions or requirements or needs may change subsequent to providing the initial positioning configuration, with those changes affecting one or both the configured positioning measurements and the configured positioning assistance data.

Broadly, the network node determines one or more modifications for at least one of the positioning-measurement instructions and the positioning-assistance data and sends modification signaling while the wireless device is operating according to the positioning configuration, to thereby modify at least one of the positioning-measurement instructions or the positioning-assistance data at the wireless device with respect to one or more future occurrences of the defined event. This “modification signaling” allows the LMF or other network node to change the positioning measurement instructions and/or positioning assistance data used by the device without disturbing the event triggering, which can be understood as preserving continuity or coherence with respect to the event definition.

As a particular example, consider configuring the device for periodic triggering of event reporting, according to a defined periodicity—the “event” configuration—and according to initial positioning assistance data and positioning measurement instructions. By using modification signaling, e.g., LPP messages embedded in LCS communications, the network can modify how or what the device measures, e.g., in response to the device transitioning between indoors and outdoors or transitioning into or out of an IoT sensor environment, without disturbing the periodicity of the device's reporting.

Modifying the positioning assistance data comprises, for example, changing which TRPs 12 are candidates for measurement or prioritization, or are to be excluded, or changing the number of TRPs 12 that the wireless device should consider at any one time, or data indicating sensors to be used for proximity-based racking. Modifying the positioning-measurement instructions comprises, for example, changing from reporting elevation to not reporting elevation, for example, or changing from positioning measurements to tracking measurements—e.g., reporting which sensor(s) are proximate. Of course, these changes are non-limiting examples.

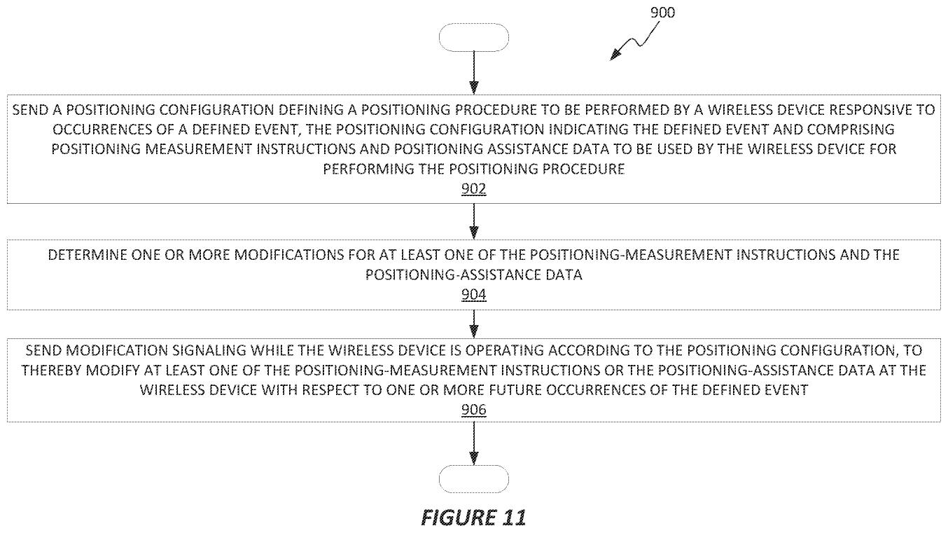

FIG. 9 illustrates an example embodiment of the communication network 10 introduced in FIG. 3. A Radio Access Network (RAN) 46 of the network 10 includes a gNB 50-1 (a 5G base station) and an ng-eNB 50-2 (an E-UTRAN base station coupled to a 5G Core Network or CN). Here, depiction of the CN 48 is simplified, with selected entities illustrated. Shown in the figure, the CN 48 includes an Application Management Function (AMF) 52, a Location Management Function (LMF) 54, which may be coupled with an Evolved Serving Mobile Location Center (EMC) 56 and/or a SUPL Location Platform (SLP) 58.

The interfaces/interconnections between the depicted entities conforms with 3GPP nomenclature for 5G networks. Other embodiments of the network 10 may have similar or equivalent entities but may use different nomenclature and/or interfaces. Also, the gNB 50-1 and eNB 50-2 each may provide or operate as one or more TRPs 12, or, at least in the context of positioning, one or both of them may operate as TPs only, e.g., transmitting one or more PRS or other reference signals for positioning measurements. With respect to the BS 30 depicted in FIG. 2, the gNB 50-1 and eNB 50-2 may be understood as specific examples of particular types of BSs 30.

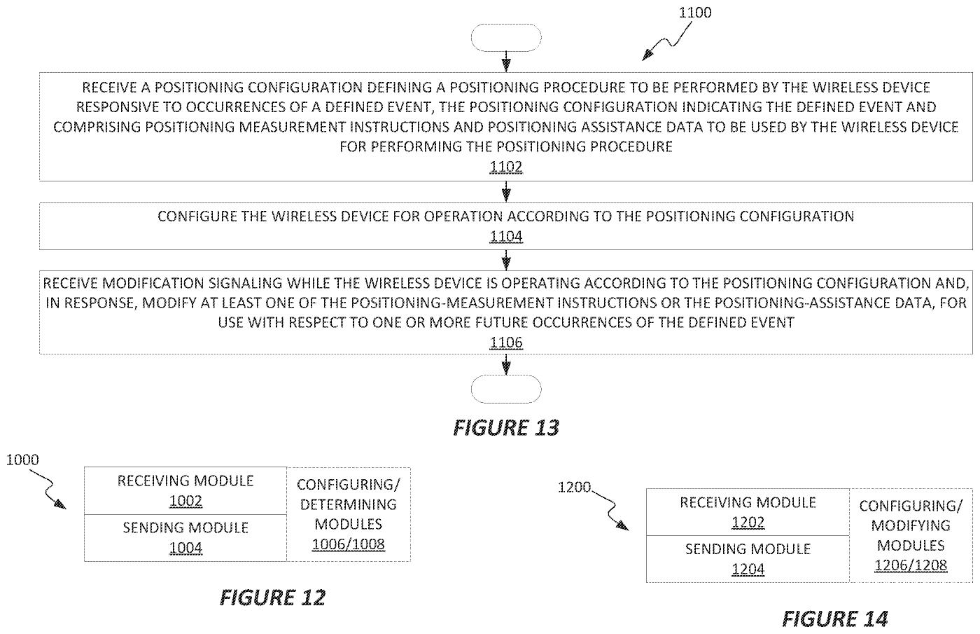

FIG. 10 illustrates example embodiments of an LMF 54, a BS 30 (e.g., either gNB 50-1 or ng-eNB 50-2), and a UE 20.

The example LMF 54 includes communication interface circuitry 60, including transmitter circuitry 62 and receiver circuitry 64. The communication interface circuitry 60 comprises, for example, physical-layer circuitry for wired or wireless transmission of signals and reception of signals. In one example, the communication interface circuitry 60 comprises a network communication interface, e.g., Ethernet or another data/signaling interface. The communication interface circuitry 60 is configured to communicatively coupled the LMF 54 to one or more other network nodes, such as AMFs 52, EMCs 56, SLPs 58, and/or BSs 30. Although the LMF 54 may use such circuitry for communicating with respective BSs 30, e.g., via an AMF 52, the LMF 54 also may use such circuitry for communicating with wireless devices 20 using AMF 52/BSs 30 as intermediary nodes in an overall end-to-end connection.

The LMF 54 further includes processing circuitry 66 which may include or be associated with storage 68, e.g., for storing one or more computer programs (CPs) 70 and/or one or more types of configuration data (DATA) 72. The storage 68 comprises one or more types of computer-readable media, such as one or more types of memory circuits or devices or storage devices, with non-limiting examples including SRAM, DRAM, FLASH, EEPROM, Solid State Disk (SSD), electromagnetic disk, etc. However, implemented, in one or more embodiments of the LMF 54, the storage 68 provides for non-transitory storage of computer program instructions that, when executed by one or more microprocessors or other digital processors, form the processing circuitry 66.

That is, the processing circuitry 66 may comprise one or more microprocessors, microcontrollers, or the like, that are specially adapted to carry out the operations described herein for the LMF 54, based on the execution of computer program instructions stored as one or more CPs 70 in the storage 68. More broadly, the processing circuitry 66 comprises fixed or dedicated circuitry, or programmatically-configured circuitry, or a mix of fixed and programmatically-configured circuitry.

The processing circuitry 66 is operatively associated with the communication interface circuitry 60. “Operatively associated” in this regard means that the processing circuitry 66 is operative to transmit and receive messages or other signaling via the communication interface circuitry. As such, when referring to the processing circuitry 66 receiving information or sending information, it may be understood that such receiving or sending may involve the processing circuitry 66 interacting with the communication interface circuitry 60.

The example BS 30 includes communication interface circuitry 80, including transmitter circuitry 82-1 and receiver circuitry 84-1. The transmitter circuitry 82-1 and the receiver circuitry 84-1 comprises, for example, physical-layer circuitry for wired or wireless transmission of signals and reception of signals. In one example, the transmitter circuitry 82-1 and the receiver circuitry 84-1 comprise a network communication interface, e.g., Ethernet or another data/signaling interface, for communicating with one or more other network nodes, such as other BSs 30 and/or with one or more nodes in the CN 48, such as AMFs 52 and/or LMFs 54.

The communication interface circuitry 80 further includes transmitter circuitry 82-2 and receiver circuitry 84-2, which may couple to one or more transmit/receive antennas 88 via antenna interface circuitry 86. The transmit/receive antennas 88 may comprise antenna arrays or multi-element antenna systems for transmit and/or receive beamforming. The transmitter circuitry 82-2 and the receiver circuitry 84-2 comprise, for example, radiofrequency circuitry and associated intermediate and/or baseband circuitry that is configured for providing a 5G NR air interface and/or other type of air interface, for transmitting DL signals to wireless devices 20 and receiving UL signals from wireless devices 20.

The BS 30 further includes processing circuitry 90 which may include or be associated with storage 92, e.g., for storing one or more computer programs (CPs) 94 and/or one or more types of configuration data (DATA) 96. The storage 92 comprises one or more types of computer-readable media, such as one or more types of memory circuits or devices or storage devices, with non-limiting examples including SRAM, DRAM, FLASH, EEPROM, Solid State Disk (SSD), electromagnetic disk, etc. However, implemented, in one or more embodiments of the BS 30, the storage 92 provides for non-transitory storage of computer program instructions that, when executed by one or more microprocessors or other digital processors, form the processing circuitry 90.

That is, the processing circuitry 90 may comprise one or more microprocessors, microcontrollers, or the like, that are specially adapted to carry out the operations described herein for the BS 30, based on the execution of computer program instructions stored as one or more CPs 94 in the storage 92. More broadly, the processing circuitry 90 comprises fixed or dedicated circuitry, or programmatically-configured circuitry, or a mix of fixed and programmatically-configured circuitry. The processing circuitry 90 is operatively associated with the communication interface circuitry 80, e.g., for sending and receiving signaling with respect to one or more other nodes in the network 10 and/or with respect to sending and receiving signaling with respect to wireless devices 20.

The example wireless device 20 (labeled UE in the figure) includes communication interface circuitry 100, including transmitter circuitry 102 and receiver circuitry 104, which may couple to one or more transmit/receive antennas 108 via antenna interface circuitry 106. The transmit/receive antennas 108 may comprise antenna arrays or multi-element antenna systems for transmit and/or receive beamforming. The transmitter circuitry 102 and the receiver circuitry 104 comprise, for example, radiofrequency circuitry and associated intermediate and/or baseband circuitry that is configured for transmitting and receiving on a 5G NR air interface and/or other type of air interface, for receiving DL signals and transmitting UL signals.

The wireless device 20 further includes processing circuitry 110 which may include or be associated with storage 112, e.g., for storing one or more computer programs (CPs) 114 and/or one or more types of configuration data (DATA) 116. The storage 112 comprises one or more types of computer-readable media, such as one or more types of memory circuits or devices or storage devices, with non-limiting examples including SRAM, DRAM, FLASH, EEPROM, Solid State Disk (SSD), electromagnetic disk, etc. However, implemented, in one or more embodiments of the wireless device 20, the storage 112 provides for non-transitory storage of computer program instructions that, when executed by one or more microprocessors or other digital processors, form the processing circuitry 110.

That is, the processing circuitry 110 may comprise one or more microprocessors, microcontrollers, or the like, that are specially adapted to carry out the operations described herein for the wireless device 20, based on the execution of computer program instructions stored as one or more CPs 114 in the storage 112. More broadly, the processing circuitry 110 comprises fixed or dedicated circuitry, or programmatically-configured circuitry, or a mix of fixed and programmatically-configured circuitry. The processing circuitry 110 is operatively associated with the communication interface circuitry 100, e.g., for sending and receiving signaling with respect to the network 10, e.g., with respect to TRPs 12 of the network 10.

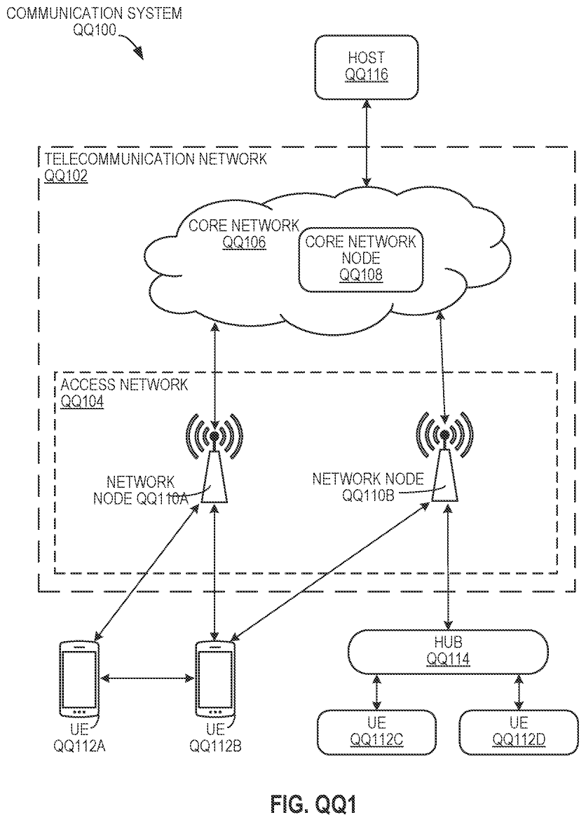

FIG. 11 illustrates a method 900 performed by an LMF, e.g., the LMF 54 of FIG. 10 may be configured to carry out the operations of the method 900. The method 900 includes the LMF sending (Block 902) a positioning configuration defining a positioning procedure to be performed by a wireless device responsive to occurrences of a defined event, the positioning configuration indicating the defined event and comprising positioning measurement instructions and positioning assistance data to be used by the wireless device for performing the positioning procedure.

The method 900 further includes the LMF determining (Block 904) one or more modifications for at least one of the positioning-measurement instructions and the positioning-assistance data, and sending (Block 906) modification signaling while the wireless device is operating according to the positioning configuration, to thereby modify at least one of the positioning-measurement instructions or the positioning-assistance data at the wireless device with respect to one or more future occurrences of the defined event.

The positioning procedure is a triggered procedure, for example, that is triggered responsive to the wireless device detecting fulfillment of the defined event, or a periodic procedure repeated according to a periodicity specified as the defined event, or a device-available location procedure performed responsive to the wireless device becoming available as the defined event.

In a particular example, the positioning procedure is a Deferred 5GC-MT-LR Procedure or a Deferred 5GC-MO-LR procedure, according to the Technical Specification (TS) 23.273 promulgated by the Third Generation Partnership Project (3GPP).

Sending the modification signaling comprises sending modified positioning-measurement instructions in one or more embodiments or operational scenarios, such that sending the modification signaling comprises sending modified positioning-assistance data.

In at least one embodiment, sending the positioning configuration comprises sending a Location Services (LCS) request, requesting invocation of periodically-triggered location reporting by the wireless device, and sending the modification signaling comprises sending one or more LTE Positioning Protocol (LPP) embedded in an LCS message sent for the wireless device subsequent to the LCS request.

Determining the one or more modifications comprises, for example, the LMF 54 determining the one or more modifications to account for the wireless device moving from an indoor coverage scenario to an outdoor coverage scenario, or vice versa. Additionally, or alternatively, determining the one or more modifications comprises determining the one or more modifications to account for the wireless device moving into or out of a predefined service area of the wireless communication network, or moving between predefined sectors of the predefined service area. See FIG. 8 for an example of predefined areas and/or sectors. Such capability allows, for example, the LMF 54 to account for where in an industrial area or other environment the next positioning event will occur, or, at least, where that next event is expected to occur. More particularly, this capability allows the LMF 54 to optimize or otherwise tailor the particular positioning measurement instructions and/or the particular positioning assistance data that are used by the wireless device for a deferred positioning event, e.g., the next upcoming periodically-triggered positioning event.

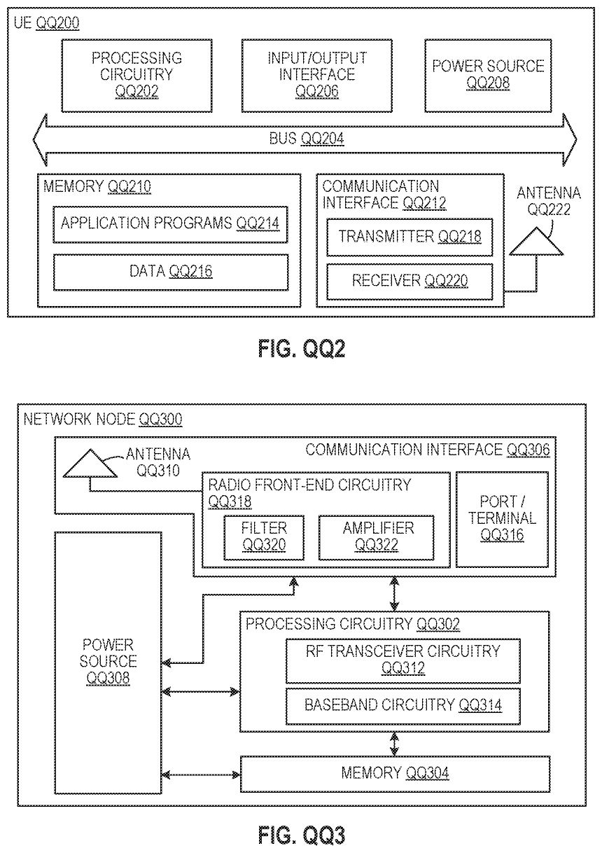

FIG. 12 illustrates another embodiment of an LMF, where the LMF comprises a set of processing units or modules 1000, including a receiving module 1002, a sending module 1004, a configuring module 1006 and a determining module 1008, shown together as “configuring/determining modules 1006/1008”. The receiving module 1002 is configured, for example, to receive periodic or other event-based location reports from a wireless device 20, the sending module 1004 is configured, for example, to transmit initial event-based positioning configuration information, and subsequent modification signaling for tailoring positioning operations for an upcoming or next one among periodic location reports. The configuring/determining modules 1006/1008 are configured to determine initial event-based positioning configurations and changes thereto, e.g., based on changing location of the wireless device, changing requirements, changing network conditions, etc. The modules 1000 are realized, in an example embodiment, based on the execution of computer program instructions by one or more microprocessors or other digital processing circuits of the LMF.

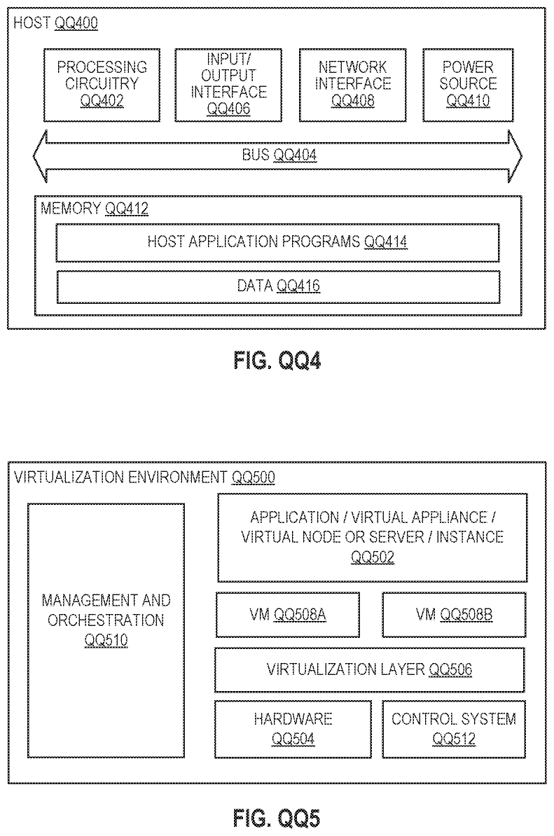

FIG. 13 depicts one embodiment of a method 1100 of operation by a wireless device, such as the wireless device 20 in FIG. 10. The method 1100 includes receiving (Block 1102) a positioning configuration defining a positioning procedure to be performed by the wireless device responsive to occurrences of a defined event, the positioning configuration indicating the defined event and comprising positioning measurement instructions and positioning assistance data to be used by the wireless device for performing the positioning procedure. Further, the method 1100 comprises configuring (Block 1104) the wireless device for operation according to the positioning configuration. Still further, the method 1100 includes the wireless device receiving (Block 1106) modification signaling while the wireless device is operating according to the positioning configuration and, in response, modifying at least one of the positioning-measurement instructions or the positioning-assistance data, for use with respect to one or more future occurrences of the defined event.

In one or more embodiments or example operating scenarios, the positioning procedure is a triggered procedure that is triggered responsive to the wireless device detecting fulfillment of the defined event, or a periodic procedure repeated according to a periodicity specified as the defined event.

In a particular example, the positioning procedure is a Deferred 5GC-MT-LR Procedure or a Deferred 5GC-MO-LR procedure, according to the Technical Specification (TS) 23.273 promulgated by the Third Generation Partnership Project (3GPP).

Receiving the modification signaling in one or more embodiments or example operating scenarios comprises receiving modified positioning-measurement instructions, and the method 1100 further comprises the wireless device carrying out a subsequent performance of the positioning procedure according to the modified positioning-measurement instructions.

Receiving the modification signaling comprises, for example, receiving modified positioning-assistance data, with the method 1100 including the wireless device carrying out a subsequent performance of the positioning procedure according to the modified positioning-assistance data.

As a particular example, receiving (Block 1102) the positioning configuration comprises receiving a Location Services (LCS) request, requesting invocation of periodically-triggered location reporting by the wireless device, configuring (Block 1104) the wireless device for operation according to the positioning configuration comprises configuring the wireless device for periodic location reporting according to the positioning-measurement instructions and the positioning-assistance data included in or provided with the LCS request, and receiving (Block 1106) the modification signaling comprises receiving one or more LTE Positioning Protocol (LPP) embedded in an LCS message received subsequent to the LCS request. Correspondingly, the method 1100 in such an embodiment may include the wireless device modifying the at least one of the positioning-measurement instructions or the positioning-assistance data comprising modifying the at least one of the positioning-measurement instructions or the positioning-assistance data, according to the contents of the one or more embedded LPP messages.

In an example embodiment, the modification signaling modifies the positioning assistance data by indicates particular TRPs 12 of a wireless communication network, e.g., the network 10, that are allowed, prioritized, or excluded from consideration by the wireless device 20 in the next periodic location report. As noted, the wireless device may have received general positioning assistance data via broadcasting and may receive the incremental assistance data via unicasting. The general positioning assistance data may identify all TRPs 12 for a potentially broad geographic area, whereas the incremental assistance data is relevant to the position of the wireless device 20 when performing measurements in support of the next periodic location report. That location may be known or predicated by the LMF, with respect to generating the incremental assistance data and, more generally, the broader “modification signaling” described herein.

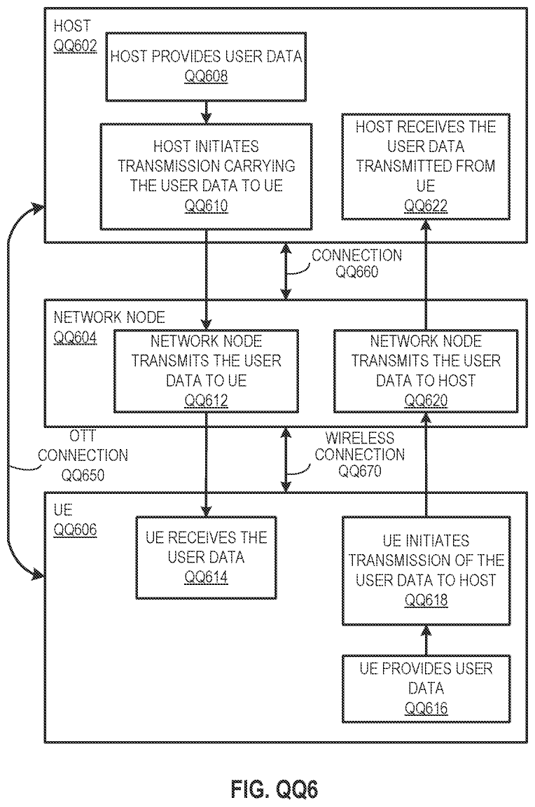

FIG. 14 illustrates another embodiment of a wireless device, where the wireless device comprises a set of processing units or modules 1200, including a receiving module 1202, a sending module 1204, a configuring module 1206 and a modifying module 1208 (shown as “configuring/modifying modules 1206/1208”). The sending module 1204 is configured, for example, to send periodic location reports, the receiving module 1202 is configured, for example, to receive positioning configurations and corresponding modification signaling, the configuring module 1206 is configured, for example, to configure the wireless device to operate according to a received positioning configuration, and the modifying module 1208 is configured to modify the positioning measurement instructions and/or positioning assistance data in such a positioning configuration, such that the device operates according to the modifications. The modules 1200 are realized, in an example embodiment, based on the execution of computer program instructions by one or more microprocessors or other digital processing circuits of the wireless device.

FIG. QQ1 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3^{rd} Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102 and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. QQ1 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio—Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs.

Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

FIG. QQ2 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. QQ2. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. QQ2.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. QQ3 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeB s. In such a scenario, each unique NodeB and RNC pair, may in some instances be considered a single separate network node.

In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302.

The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection.

The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. QQ3 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

FIG. QQ4 is a block diagram of a host QQ400, which may be an embodiment of the host QQ116 of FIG. QQ1, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as Figures QQ2 and QQ3, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400, or data generated by the host QQ400 for a UE. Embodiments of the host QQ400 may utilize only a subset, or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems).

The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. QQ5 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g., such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

FIG. QQ6 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. QQ1 and/or UE QQ200 of FIG. QQ2), network node (such as network node QQ110a of FIG. QQ1 and/or network node QQ300 of FIG. QQ3), and host (such as host QQ116 of FIG. QQ1 and/or host QQ400 of FIG. QQ4) discussed in the preceding paragraphs will now be described with reference to FIG. QQ6.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. QQ1) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the latency and power consumption associated with event-based positioning, e.g., for LCS, along with reducing signaling overhead, and thereby provide benefits such as improving the user experience or improving the interactions of the OTT service with the wireless communication network, e.g., with reduced waiting times, more economical use of LCS, etc.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency, and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above or supplying values of other physical quantities from which software may compute or estimate the monitored quantities.

The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination.

Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionalities may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole, and/or by end users and a wireless network generally.

Example embodiments include at least the following:

Group A Embodiments

1. A method performed by a wireless device, the method comprising:
receiving a positioning configuration defining a positioning procedure to be performed by the wireless device responsive to occurrences of a defined event, the positioning configuration indicating the defined event and comprising positioning measurement instructions and positioning assistance data to be used by the wireless device for performing the positioning procedure;
configuring the wireless device for operation according to the positioning configuration; and
receiving modification signaling while the wireless device is operating according to the positioning configuration and, in response, modifying at least one of the positioning-measurement instructions or the positioning-assistance data, for use with respect to one or more future occurrences of the defined event.

2. The method according to embodiment 1, wherein the positioning procedure is a triggered procedure that is triggered responsive to the wireless device detecting fulfillment of the defined event, or a periodic procedure repeated according to a periodicity specified as the defined event.

3. The method according to embodiment 1 or embodiment 2, wherein the positioning procedure is a Deferred 5GC-MT-LR Procedure or a Deferred 5GC-MO-LR procedure, according to the Technical Specification (TS) 23.273 promulgated by the Third Generation Partnership Project (3GPP).

4. The method according to any of embodiments 1-3, wherein receiving the modification signaling comprises receiving modified positioning-measurement instructions, and wherein the method further comprises carrying out a subsequent performance of the positioning procedure according to the modified positioning-measurement instructions.

5. The method according to any of embodiments 1-3, wherein receiving the modification signaling comprises receiving modified positioning-assistance data, and wherein the method further comprises carrying out a subsequent performance of the positioning procedure according to the modified positioning-assistance data.

6. The method of any of embodiments 1-5, wherein,
receiving the positioning configuration comprises receiving a Location Services (LCS) request, requesting invocation of periodically-triggered location reporting by the wireless device;
configuring the wireless device for operation according to the positioning configuration comprises configuring the wireless device for periodic location reporting according to the positioning-measurement instructions and the positioning-assistance data included in or provided with the LCS request;
receiving the modification signaling comprises receiving one or more LTE Positioning Protocol (LPP) messages embedded in an LCS message received subsequent to the LCS request; and
modifying the at least one of the positioning-measurement instructions or the positioning-assistance data comprises modifying the at least one of the positioning-measurement instructions or the positioning-assistance data, according to the contents of the one or more embedded LPP messages.

Group B Embodiments

7. A method performed by a network node of a wireless communication network, the method comprising:
sending a positioning configuration defining a positioning procedure to be performed by a wireless device responsive to occurrences of a defined event, the positioning configuration indicating the defined event and comprising positioning measurement instructions and positioning assistance data to be used by the wireless device for performing the positioning procedure;
determining one or more modifications for at least one of the positioning-measurement instructions and the positioning-assistance data; and
sending modification signaling while the wireless device is operating according to the positioning configuration, to thereby modify at least one of the positioning-measurement instructions or the positioning-assistance data at the wireless device with respect to one or more future occurrences of the defined event.

8. The method according to embodiment 7, wherein the positioning procedure is a triggered procedure that is triggered responsive to the wireless device detecting fulfillment of the defined event, or a periodic procedure repeated according to a periodicity specified as the defined event.

9. The method according to embodiment 7 or embodiment 8, wherein the positioning procedure is a Deferred 5GC-MT-LR Procedure or a Deferred 5GC-MO-LR procedure, according to the Technical Specification (TS) 23.273 promulgated by the Third Generation Partnership Project (3GPP).

10. The method according to any of embodiments 7-9, wherein sending the modification signaling comprises sending modified positioning-measurement instructions.

11. The method according to any of embodiments 7-9, wherein sending the modification signaling comprises sending modified positioning-assistance data.

12. The method of any of embodiments 7-11, wherein,
sending the positioning configuration comprises sending a Location Services (LCS) request, requesting invocation of periodically-triggered location reporting by the wireless device; and
sending the modification signaling comprises sending one or more LTE Positioning Protocol (LPP) messages embedded in an LCS message sent for the wireless device subsequent to the LCS request.

13. The method of any of embodiments 7-12, wherein determining the one or more modifications comprises determining the one or more modifications to account for the wireless device moving from an indoor coverage scenario to an outdoor coverage scenario, or vice versa.

14. The method of any of embodiments 7-12, wherein determining the one or more modifications comprises determining the one or more modifications to account for the wireless device moving into or out of a predefined service area of the wireless communication network or moving between predefined sectors of the predefined service area.

Group C Embodiments

15. A user equipment comprising:
processing circuitry configured to perform any of the steps of any of the Group A embodiments; and
power supply circuitry configured to supply power to the processing circuitry.

16. A network node comprising:
processing circuitry configured to perform any of the steps of any of the Group B embodiments; and

power supply circuitry configured to supply power to the processing circuitry.

17. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

18. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to receive the user data from the host.

19. The host of the previous embodiment, wherein the cellular network further includes a network node configured to communicate with the UE to transmit the user data to the UE from the host.

20. The host of the previous 2 embodiments, wherein:
the processing circuitry of the host is configured to execute a host application, thereby providing the user data; and
the host application is configured to interact with a client application executing on the UE, the client application being associated with the host application.

21. A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of the operations of any of the Group A embodiments to receive the user data from the host.

22. The method of the previous embodiment, further comprising:

at the host, executing a host application associated with a client application executing on the UE to receive the user data from the UE.

23. The method of the previous embodiment, further comprising:
at the host, transmitting input data to the client application executing on the UE, the input data being provided by executing the host application,
wherein the user data is provided by the client application in response to the input data from the host application.

24. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to transmit the user data to the host.

25. The host of the previous embodiment, wherein the cellular network further includes a network node configured to communicate with the UE to transmit the user data from the UE to the host.

26. The host of the previous 2 embodiments, wherein:
the processing circuitry of the host is configured to execute a host application, thereby providing the user data; and
the host application is configured to interact with a client application executing on the UE, the client application being associated with the host application.

27. A method implemented by a host configured to operate in a communication system that further includes a network node and a user equipment (UE), the method comprising:
at the host, receiving user data transmitted to the host via the network node by the UE, wherein the UE performs any of the steps of any of the Group A embodiments to transmit the user data to the host.

28. The method of the previous embodiment, further comprising:

at the host, executing a host application associated with a client application executing on the UE to receive the user data from the UE.

29. The method of the previous embodiment, further comprising:
at the host, transmitting input data to the client application executing on the UE, the input data being provided by executing the host application,
wherein the user data is provided by the client application in response to the input data from the host application.

30. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

31. The host of the previous embodiment, wherein:
the processing circuitry of the host is configured to execute a host application that provides the user data; and
the UE comprises processing circuitry configured to execute a client application associated with the host application to receive the transmission of user data from the host.

32. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations of any of the Group B embodiments to transmit the user data from the host to the UE.

33. The method of the previous embodiment, further comprising, at the network node, transmitting the user data provided by the host for the UE.

34. The method of any of the previous 2 embodiments, wherein the user data is provided at the host by executing a host application that interacts with a client application executing on the UE, the client application being associated with the host application.

35. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

36. The communication system of the previous embodiment, further comprising:
the network node; and/or
the user equipment.

37. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

38. The host of the previous 2 embodiments, wherein:
the processing circuitry of the host is configured to execute a host application, thereby providing the user data; and
the host application is configured to interact with a client application executing on the UE, the client application being associated with the host application.

39. The host of the any of the previous 2 embodiments, wherein the initiating receipt of the user data comprises requesting the user data.

40. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs any of the steps of any of the Group B embodiments to receive the user data from the UE for the host.

41. The method of the previous embodiment, further comprising at the network node, transmitting the received user data to the host.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1. A method performed by a wireless device, the method comprising:
receiving a positioning configuration from a network node of a wireless communication network, the positioning configuration defining a positioning procedure to be performed by the wireless device responsive to occurrences of a defined event, the positioning configuration indicating the defined event and comprising positioning measurement instructions and positioning assistance data to be used by the wireless device for performing the positioning procedure;
configuring the wireless device for operation according to the positioning configuration; and
receiving modification signaling while the wireless device is operating according to the positioning configuration and, in response, modifying at least one of the positioning-measurement instructions or the positioning-assistance data, for use with respect to one or more future occurrences of the defined event.

2. The method according to claim 1, wherein the positioning procedure is a triggered procedure that is triggered responsive to the wireless device detecting fulfillment of the defined event, or a periodic procedure repeated according to a periodicity specified as the defined event.

3. The method according to claim 1, wherein the positioning procedure is a Deferred 5GC-MT-LR Procedure or a Deferred 5GC-MO-LR procedure, according to the Technical Specification (TS) 23.273 promulgated by the Third Generation Partnership Project (3GPP).

4. The method according to claim 1, wherein receiving the modification signaling comprises receiving modified positioning-measurement instructions, and wherein the method further comprises carrying out a subsequent performance of the positioning procedure according to the modified positioning-measurement instructions.

5. The method according to claim 1, wherein receiving the modification signaling comprises receiving modified positioning-assistance data, and wherein the method further comprises carrying out a subsequent performance of the positioning procedure according to the modified positioning-assistance data.

6. The method according to claim 1, wherein,
receiving the positioning configuration comprises receiving a Location Services (LCS) request, requesting invocation of periodically-triggered location reporting by the wireless device;
configuring the wireless device for operation according to the positioning configuration comprises configuring the wireless device for periodic location reporting according to the positioning-measurement instructions and the positioning-assistance data included in or provided with the LCS request;
receiving the modification signaling comprises receiving one or more LTE Positioning Protocol (LPP) messages embedded in a LCS message received subsequent to the LCS request; and
modifying the at least one of the positioning-measurement instructions or the positioning-assistance data comprises modifying the at least one of the positioning-measurement instructions or the positioning-assistance data, according to the contents of the one or more embedded LPP messages.

7. A method performed by a network node of a wireless communication network, the method comprising:
sending a positioning configuration defining a positioning procedure to be performed by a wireless device responsive to occurrences of a defined event, the positioning configuration indicating the defined event and comprising positioning measurement instructions and positioning assistance data to be used by the wireless device for performing the positioning procedure;
determining one or more modifications for at least one of the positioning-measurement instructions and the positioning-assistance data; and
sending modification signaling while the wireless device is operating according to the positioning configuration, to thereby modify at least one of the positioning-measurement instructions or the positioning-assistance data at the wireless device with respect to one or more future occurrences of the defined event.

8. The method according to claim 7, wherein e positioning procedure is a triggered procedure that is triggered responsive to the wireless device detecting fulfillment of the defined event, or a periodic procedure repeated according to a periodicity specified as the defined event.

9. The method according to claim 7, wherein the positioning procedure is a Deferred 5GC-MT-LR Procedure or a Deferred 5GC-MO-LR procedure, according to the Technical Specification (TS) 23.273 promulgated by the Third Generation Partnership Project (3GPP).

10. The method according to claim 7, wherein sending the modification signaling comprises sending modified positioning-measurement instructions.

11. The method according to claim 7, wherein sending the modification signaling comprises sending modified positioning-assistance data.

12. The method according to claim 7, wherein,
sending the positioning configuration comprises sending a Location Services (LES) request, requesting invocation of periodically-triggered location reporting by the wireless device; and
sending the modification signaling comprises sending one or more LTE Positioning Protocol (LPP) messages embedded in an LCS message sent for the wireless device subsequent to the LCS request.

13. The method according to claim 7, wherein determining the one or more modifications comprises determining the one or more modifications to account for the wireless device moving from an indoor coverage scenario to an outdoor coverage scenario, or vice versa.

14. The method according to claim 7, wherein determining the one or more modifications comprises determining the one or more modifications to account for the wireless device moving into or out of a predefined service area of the wireless communication network or moving between predefined sectors of the predefined service area.

15. A wireless device comprising:
communication interface circuitry; and
processing circuitry configured to:
receive, via the communication interface circuitry, signaling from a network node of a wireless communication network, the signaling conveying a positioning configuration defining a positioning procedure to be performed by the wireless device responsive to occurrences of a defined event, the positioning configuration indicating the defined event and comprising positioning measurement instructions and positioning assistance data to be used by the wireless device for performing the positioning procedure;
configure the wireless device for operation according to the positioning configuration; and
receive, via the communication interface circuitry, modification signaling while the wireless device is operating according to the positioning configuration and, in response, modifying at least one of the positioning-measurement instructions or the positioning-assistance data, for with respect to one or more future occurrences of the defined event.

16. The wireless device according to claim 15, wherein the positioning procedure is a triggered procedure that is triggered responsive to the wireless device detecting fulfillment of the defined event, or a periodic procedure repeated according to a periodicity specified as the defined event.

17. The wireless device according to claim 15, wherein the positioning procedure is a Deferred 5GC-MT-LR Procedure or a Deferred 5GC-MO-LR procedure, according to the Technical Specification (TS) 23.273 promulgated by the Third Generation Partnership Project (3GPP).

18. The wireless device according to claim 15, wherein the modification signaling comprises modified positioning-measurement instructions, and wherein the processing circuitry is configured to control the wireless device to carry out a subsequent performance of the positioning procedure according to the modified positioning-measurement instructions.

19. The wireless device according to claim 15, wherein the modification signaling comprises modified positioning-assistance data, and wherein the processing circuitry is configured to control the wireless device to carry out a subsequent performance of the positioning procedure according to the modified positioning-assistance data.

20. The wireless device according to claim 15, wherein,
the positioning configuration is received as a Location Services (LCS) request, requesting invocation of periodically-triggered location reporting by the wireless device;
the processing circuit is configured to configure the wireless device for periodic location reporting according to the positioning-measurement instructions and the positioning-assistance data included in or provided with the LCS request;
the modification signaling comprises one or more LTE Positioning Protocol (LPP) messages embedded in an LCS message received subsequent to the LCS request; and
the processing circuitry is configured to modify the at least one of the positioning-measurement instructions or the positioning-assistance data by modifying the at least one of the positioning-measurement instructions or the positioning-assistance data, according to the contents of the one or more embedded LPP messages.

21. A network node of a wireless communication network, the network node comprising:
communication interface circuitry; and
processing circuitry configured to:
send, via the communication interface circuitry, a positioning configuration defining a positioning procedure to be performed by a wireless device responsive to occurrences of a defined event, the positioning configuration indicating the defined event and comprising positioning measurement instructions and positioning assistance data to be used by the wireless device for performing the positioning procedure;
determine one or more modifications for at least one of the positioning-measurement instructions and the positioning-assistance data; and
send, via the communication interface circuitry, modification signaling while the wireless device is operating according to the positioning configuration, to thereby modify at least one of the positioning-measurement instructions or the positioning-assistance data at the wireless device with respect to one or more future occurrences of the defined event.

22. The network node according to claim 21, wherein the positioning procedure is a triggered procedure that is triggered responsive to the wireless device detecting fulfillment of the defined event, or a periodic procedure repeated according to a periodicity specified as the defined event.

23. The network node according to claim 21, wherein the positioning procedure is a Deferred 5GC-MT-LR Procedure or a Deferred 5GC-MO-LR procedure, according to the Technical Specification (TS) 23.273 promulgated by the Third Generation Partnership Project (3GPP).

24. The network node according to claim 21, wherein the processing circuitry is configured to send modified positioning-measurement instructions as the modification signaling.

25. The network node according to claim 21, wherein the processing circuitry is configured to send modified positioning-assistance data as the modification signaling.

26. The network node according to claim 21, wherein the processing circuitry is configured to:
send the positioning configuration as a Location Services (LCS) request, requesting invocation of periodically-triggered location reporting by the wireless device; and
send the modification signaling as one or more LTE Positioning Protocol (LPP) messages embedded in an LCS message sent for the wireless device subsequent to the LCS request.

27. The network node according to claim 21, wherein the processing circuitry is configured to determine the one or more modifications as one or more modifications to account for the wireless device moving from an indoor coverage scenario to an outdoor coverage scenario, or vice versa.

28. The network node according to claim 21, wherein the processing circuitry is configured to determine the one or more modifications as one or more modifications to account for the wireless device moving into or out of a predefined service area of the wireless communication network or moving between predefined sectors of the predefined service area.
